(19) United States
(12) Patent Application Publication
(10) Pub. No.: US 2010/0261286 A1
(43) Pub. Date: Oct. 14, 2010

(54) Microfluidic devices and methods of preparing and using the same

(76) Inventors: Young Hoon Kim, Princeton Junction, NJ (US); Muntak Son, Kyoungsangbookdo (KR)

Correspondence Address: LUCAS & MERCANTI, LLP, 475 PARK AVENUE SOUTH, 15TH FLOOR, NEW YORK, NY, 10016, US

(21) Appl. No.: 11/487,151

(22) Filed: Jul. 14, 2006

Related U.S. Application Data
(60) Provisional application No. 60/699,580, filed on Jul. 14, 2005.

(51) Int. Cl. G01N 27/419; G01N 30/00; G01N 27/22; G01N 21/00; G01N 27/26

(52) U.S. Cl. 436/149; 422/69; 422/61; 436/164; 436/172; 204/400

(57) ABSTRACT

Microfluidic devices include a photoresist layer in which an inlet chamber, an optional reaction chamber and at least one detection chamber are in fluid contact, a support arranged under the photoresist layer and a cover arranged above the photoresist layer. The devices further include a set of absorbent channels downstream of the last detection chamber. Biogenic or immunoreactive substances are placed in the reaction chamber and detection chamber(s). When a liquid sample is dropped into the inlet chamber, the sample liquid is drawn through the devices by capillary action. Detection methods include electrochemical detection, colorimetric detection and fluorescence detection.

### CROSS-REFERENCE TO RELATED APPLICATIONS

This application claims the benefit of priority from U.S. Provisional Application Ser. No. 60/699,580 filed Jul. 14, 2005, the contents of which are incorporated herein by reference.

### FIELD OF THE INVENTION

The field of the invention relates generally to microfluidic devices, fabrication methods for microfluidic devices and the use of microfluidic devices in biological assays.

### BACKGROUND OF THE INVENTION

Point of care tests, i.e., tests which are performed at the point of care (POC), have become common diagnostic tools used in hospitals, doctors' offices, workplaces, and potentially hostile environments. Tasks such as workplace testing for drug abuse, environmental testing for pollutants, and testing for bio-warfare agents on the battlefield can be simply and easily performed with point of care tests. Since the tests are often performed by individuals having little, if any, clinical diagnostics training, point of care tests need to be simple, quick, and easy to use. Point of care tests ideally require a minimal amount of equipment.

Most current point of care tests rely on membrane-based immunochromatography assays which take advantage of the capillary action of microporous membranes. In immunochromatography assays, analytes in the mobile phase specimen solutions are separated from other components by affinity binding to capture molecules immobilized on stationary solid phases. Membranes, made of nitrocellulose or nylon, provide a matrix for the solid stationary phase of affinity chromatography and the liquid phase of partition chromatography which drives immunocomplex particles to be separated from other liquid solutes by capillary action.

Microporous membranes, made of nylon or nitrocellulose, have been used for antigen/antibody testing since about 1979 when it was first demonstrated that proteins could be transferred through a membrane. Nitrocellulose has been utilized extensively as a surface for immobilizing proteins in research techniques such as Western blotting and lateral-flow immunodiagnostics. Microporosity and nitrocellulose offer many benefits for rapid immunochromatography assays including for example, high binding capacity, non-covalent attachment of proteins, a stable long-term immobilization environment, and a milieu conducive to consistent binding.

A typical prior art rapid immunoassay kit comprises a reagent pad having a first capture antibody to which a label, such as a fluorescence label, gold label, or other label has been attached. A second capture antibody is attached to a nitrocellulose or nylon membrane strip. One end of the nitrocellulose or nylon membrane strip is placed in direct contact with the reagent pad. The second capture antibody is often bound to the membrane to form a particular geometric pattern, such as a line. When a sample containing analyte to be analyzed is applied to the reagent pad, the analyte binds to the first, labeled capture antibody to form a binding complex and then the solution containing the binding complex is drawn through the membrane strip. Within the membrane strip, the complex binds to the second membrane-bound capture antibody. The second binding may be visualized due to the concentration of the label along the geometric pattern comprising the membrane-bound capture antibody, or alternatively, the binding may be detected through other means such as fluorescence detection, or electrochemical detection.

Key parameters controlling signal intensity in immunochromatography assays are capillary flow rate and protein binding capacity of the membrane. Capillary flow rate and binding capacity are determined by the pore size, porosity, and thickness of the membrane. The protein binding capacity of the membrane depends upon its pore size, and surface properties. Nitrocellulose membranes are often treated with surfactants to aid surface wetting. One concern about use of a surfactant is that the surfactant alters the capillary flow behavior of the membrane and the degree of change is difficult to predict.

The protein binding ability of the membrane and migration speed of particles through the membrane depends on membrane pore size. Unfortunately, membrane manufacturers are unable to maintain a consistent pore size and porosity during the production of membranes due to the complicated and delicate nature of the manufacturing process. High variability in pore size and porosity is observed between production lots, and moreover even within the same production lot. It is not unusual to find more than about a 20% variation in signal intensity among different sample test kits produced under the same conditions. This variability is a major factor in rendering membrane-based immunoassays largely unsuitable for quantitative testing. The high variability restricts the use of point of care tests to qualitative analyses. While many attempts have been made to improve the behavior of microporous membranes, maintaining consistent quality remains a problem.

To resolve the variability in signal intensity, many solutions have been proposed and researched, such as improvement of the detector, alternative labeling of particles, and optimization of reagents formulation. Unfortunately, only a slight improvement in performance has resulted.

In view of the foregoing drawbacks of POC tests and their manufacture, it would be desirable to provide more accurate POC tests and methods for manufacturing POC tests which increase the accuracy of the tests and allow the tests to be used for quantitative as well as qualitative analysis.

Some POC tests use microfluidic assay devices. A variety of materials have been used to provide channels in microfluidic devices, such as silicon, glass and plastic. Each of those materials has shortcomings. Silicon and glass are not cost-effective. Silicon requires extensive chemical etching process that inactivates biomaterials during fabrication of micro channels and thus, is often not compatible with biomaterials. Plastic is usually hydrophobic so that it requires active transportation system to drive analytes to flow in channels, unlike porous membrane using passive capillary action. A film type of microfluidic device has been designed, but it uses die cutting adhesive tape to make a fluidic channel (see, for example, U.S. Pat. No. 6,919,046 to O'Coner et al., and U.S. Pat. No. 6,857,449 to Chow et al.). Alternatively, U.S. Pat. No. 6,790,599 to Madou et al. describes a microfluidic channel fabrication method using photolithography but the invention does not provide a substantially workable microfluidic device designed to analyze biochemical materials.

Most of immunochromatographic assays look like homogeneous assays which are fast, one-step, separation-free, and do not require sample pretreatment. However, separation of the unbound ligands from those bound to the receptor is in the test procedure; it is named as pseudohomogeneous assay. The separation occurs when the analyte solution passes the immobilized test line. Electrochemical assays are widely used for quantitative determination of small molecules such as glucose, lactose and inorganic materials and also applied for large molecules because of the simplicity and cost effectiveness of the method.

The technology has problems when applied to detect larger molecules by one-step assay like membrane-based immunochromatography assays. Electrochemical reactions require substrates for enzyme reactions to generate signals. Enzymes conjugated with binding substances and substrates should be deposited separately and supplied sequentially to avoid the self reaction between enzyme and substrate before binding with analyte. To perform the process, a washing step for separation of the unbound ligands from those bound to the receptor is required before measuring the binding level. In 1995, Ivnitski et al invented a one step, separation-free ampherometric immunosensor modifying a previous enzyme-channeling immunoassay. In spite of the modification, porous membrane-based immunochromatographic assays do not provide a consistent flow speed and migration time length and therefore are largely unusable for quantitative assays.

### OBJECTS AND SUMMARY OF THE INVENTION

It is an object of the present invention to provide new and improved microfluidic devices and assay kits including the same.

It is another object of the present invention to provide new and improved microfluidic devices that address drawbacks of current assay technology and are quick, inexpensive and easy-to-use, and moreover allow for quantitative detection.

It is yet another object of the present invention to provide new and improved methods for fabricating or manufacturing disposable POC tests which increase the accuracy of the tests and allow the tests to be used for quantitative as well as qualitative analysis.

It is another object of the present invention to provide new and improved methods for manufacturing disposable POC tests which avoid the disadvantages of the prior art manufacturing techniques mentioned above.

It is another object of the present invention to provide microfluidic devices that can provide for a consistent flow speed and migration time length.

Another object of the present invention is to provide new and improved methods for using microfluidic devices that are designed to address the issues associated with current assay technology and provide rapid, inexpensive, easy-to-use, quantitative assay systems.

Another object of the invention is to provide new and improved electrochemical sensor devices.

In order to achieve at least one these objects and others, one embodiment of a microfluidic device capable of conducting rapid immunoassays in accordance with the invention is a multilayer-laminate having, for example, three layers, namely a bottom support layer, an intermediate photoresist layer and a cover layer. Although any form of a support, base, substrate, layer of material or combination of such, may be used as the support layer, in one preferred embodiment, the support layer comprises a polymeric film to which binding agents may be bound. In this case, a backing substrate is attached to the support layer to provide further strength. The polymeric film may optionally be coated on one side, or a portion of one side, with a metallic film, or other coating, to which binding substances may be bound. The metallic film may be part of an electrode. One or more binding substances such as biogenic or immunoreactive antibodies or antigens can be immobilized on the polymeric film, other coating, or metallic film by direct absorption or through binding to thin monolayers such as polypyrrole, sulfonated tetrafluorethylene copolymer (NAFION®), alkoxysilane or mixtures thereof. The intermediate layer, bonded directly to the polymeric film on the same side as the metallic film, or other coating, comprises a photoresist film into which microfluidic channels and chambers are etched. The photoresist film may comprise a polyimide photoresist film such as RISTON® from DuPont. Etching may be performed by various methods well known in the art, for example by photolithography. The cover layer may comprise a polymer film which may be directly bonded to the photoresist layer to form a laminate in accordance with the invention.

In one embodiment, the photoresist layer includes at least three microfluidic regions: a sample inlet chamber or region, a reagent or reaction chamber or region, and at least one detection chamber or region. One or more mixing regions can be provided, e.g., between the inlet chamber and the reaction chamber, one or more absorbent regions can be provided, e.g., downstream of the last detection chamber, and air vent regions can also be provided. The chambers and regions, when present, are connected to one another by microfluidic channels to form a flow path for sample fluid.

In a basic use, when a sample inlet chamber receives a liquid sample containing an analyte to be analyzed, the liquid sample is drawn into the sample inlet chamber by capillary action and flows to the reaction chamber where the sample mixes with binding reagents such as labeled antibodies. The labels may comprise fluorescence labels, or electrochemical labels, or other labels well known in the art. As the sample flows out of the reagent chamber, it flows into the detection chamber. A mixing channel may optionally be placed between the reaction chamber and the first detection chamber. Thorough mixing of sample and reagents in a mixing channel insures the reaction of sample analyte and reagents. Typically, an immunocomplex is formed between an analyte and a labeled antibody. In the detection chamber(s), an analyte-antibody complex binds to a second antibody which is in turn directly bound to the detection chamber. The analyte-antibody complex is thus captured and immobilized in the detection chamber.

The amount of captured complex may be measured with a fluorescence detector, an optical detector, or with an electrical detector. The liquid sample may optionally flow through the detection chamber to the absorbent region which can take the form of a set of one or more absorbent channels. Liquid sample flow continues until the absorbent region is filled with liquid. Air in the microfluidic system is allowed to escape through one or more air vents connected to the detection chamber(s) or the absorbent region.

Microfluidic devices of the invention may be manufactured by in-line roll-to-roll processes. In an exemplifying manufacturing method, the raw materials are three rolls, a bottom layer Polyethylene terephthalate (PET) film roll, a middle layer dry photoresist roll, and a top cover layer such as PET film or an adhesive tape roll. The rolls undergo a series of unit processes such as lamination, UV exposure, alkaline washing, drying, adding metallic layers or other layers, and adding binding reagents. The three films may then be laminated together. Finally, the laminate may be cut to form individual laminate chips for use in rapid immunoassays or assay kits.

Microfluidic devices in accordance with the invention have many advantages. The materials from which the devices are fabricated are readily available, affordable, flexible, and are as thin as the nitrocellulose membranes currently used in point of care immunoassays. The microfluidic devices of the invention also have precisely defined flow channels insuring lot-to-lot flow rate consistency and allow the devices to be used for quantitative as well as qualitative assays.

Furthermore, microfluidic devices of the invention can easily and quickly determine the qualitative and quantitative properties of specific analytes in a sample solution by analyzing the binding reaction between a pair of binding substances, particularly biogenic or immunoreactive components and/or enzyme reactions between a substrate and an active enzyme. These components (hapten, specific biogenic reporters, specific biogenic ligands, antigen, antibodies, nucleic acids) have the ability to bind specifically to each other or react with other molecules (enzyme, substrate, electron mediator or nucleic acids) in aqueous test solutions and the quantitative value of bound or reacted components can be determined by electrochemical, fluorescent or optical detection.

An important feature of the invention is therefore the unique formation of a series of microfluidic channels and chambers which cooperate to enable and determine the binding or enzymatic reaction between a pair of binding substances or enzyme and substrate, respectively.

In binding assay systems, the reaction chamber or region contains a dried form of buffer reagent, biochemical reagent, antigen or antibody labeled with gold particles, enzymes, or a fluorescence dye. The detection chamber or region may comprise a coating of immobilized antibody or antigen to capture the antigen-antibody complex.

Alternatively, an electrochemical assay system may comprise a sample inlet chamber, a reaction chamber, at least one detection chamber, and an absorbent region or chamber. Each detection chamber may comprise a coating of specific enzyme or substrate which can specifically react with an analyte in the sample solution.

In one aspect of the invention, a liquid sample containing an analyte to be analyzed will flow through the system until the absorbent region or chamber is filled. The flow stops when the absorbent region or chamber is filled. Therefore, excess loading is not possible. This fluid flow phenomenon is typical of capillary flow and provides a valuable property; the precise sampling of a given test solution. In contrast to the unpredictable behavior of the absorbent pad of a membrane-based assay, a microfluidic device may be used to perform a quantitative assay.

Another advantage of the invention is that when a liquid sample comprising an analyte to be analyzed is placed in the sample inlet chamber, liquid flows into the inlet chamber by capillary action, maintaining an even and constant flow rate. The sample reaches the reaction chamber and wets the dried reagents therein. The mixture flows together through the mixing chamber, undergoing a vigorous mixing by the engineered flow channel. The major component of the dried reagent may comprise a labeled antigen or antibody or other analyte binding component. As they pass through the mixing chamber, the analyte and reagent form a strong complex.

In the detection chamber or chambers when more than one detection chamber is present, the liquid sample comprising the analyte complex flows with a lamina flow profile. In each detection chamber resides an immobilized antibody or antigen or other analyte binding agent capable of binding the previously formed complex. Upon contact with the complex, the second binding event occurs, resulting in the capture of the complex onto the detection chamber surface. Unbound complexes and other free substances are washed away to the absorbent chamber. When the absorbent region or chamber is filled, the flow stops, enabling the precise sampling required for quantitative assays.

Electrochemical detection of enzyme labeled antigen or antibody or other binding complexes is well established. A silver/silver chloride reference electrode may be used as well as gold electrodes or carbon electrodes. Alternatively, the optical detection of the fluorescence from the fluorescence dye or particle (europium or quantum particles) labeled antigen or antibody or other binding agent is another option.

Accordingly, microfluidic devices in accordance with the invention can measure analytes in sample solutions, both qualitatively and quantitatively, through analyzing the binding properties of the analyte and one or more binding substances, for example biogenic or immunoreactive substances. These binding substances such as haptens, specific biogenic reporters, specific biogenic ligands, antigens, and antibodies have the ability to bind specifically to an analyte in aqueous sample solution. In some embodiments, the analyte comprises one or more binding epitopes and binding at a first binding epitope does not prevent binding at a second binding epitope. The binding substances and analytes combine to form complexes which may be detected by optical detection, fluorescence detection, or electrochemical detection.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is an exploded view of a first embodiment of a microfluidic device in accordance with the invention.

FIG. 2A is a top view of the microfluidic device shown in FIG. 1 with the cover layer removed to provide a view of the photoresist layer.

FIG. 2B is a top view of an alternative example of a microfluidic device in accordance with the invention. 2B-1 is top view of housing encased microfluidic channel device. 2B-2 is fabricated micro fluidics channel device.

FIG. 2C is a top view of an alternative example of housing parts of a microfluidic device including upper and lower housing parts in accordance with the invention.

FIGS. 3A-3C show various alternative patterns of an absorbent region of the photoresist layer.

FIGS. 3D-F show an alternative pattern of a reaction channel or detection chamber of the photoresist layer.

FIG. 4 is a perspective view of the rapid assay kit including the microfluidic device shown in FIG. 1.

FIG. 5 is a perspective view of the rapid assay kit shown in FIG. 4 with the top housing part removed.

FIG. 6 is a cross-sectional view of the rapid assay kit shown in FIG. 4 taken along the line 6-6 of FIG. 4.

FIG. 7 shows an example of a reading unit for use with the rapid assay kit shown in FIG. 4.

FIG. 8 is a view of an electrochemical sensor device in accordance with the invention.

FIG. 9 is an exploded view of the electrochemical sensor device shown in FIG. 8.

FIGS. 10-13 show stages in the manufacture of the electrochemical sensor device shown in FIG. 8.

FIG. 14 is a graph showing the relationship between the rigidity of photoresist film and the width of channels formed therein as a function of exposure time to ultraviolet radiation.

FIG. 15 shows measure points of sample fluid flow speed.

FIG. 16 is a graph showing results of sample fluid flow speed in different microfluidic channels.

### DETAILED DESCRIPTION OF THE INVENTION

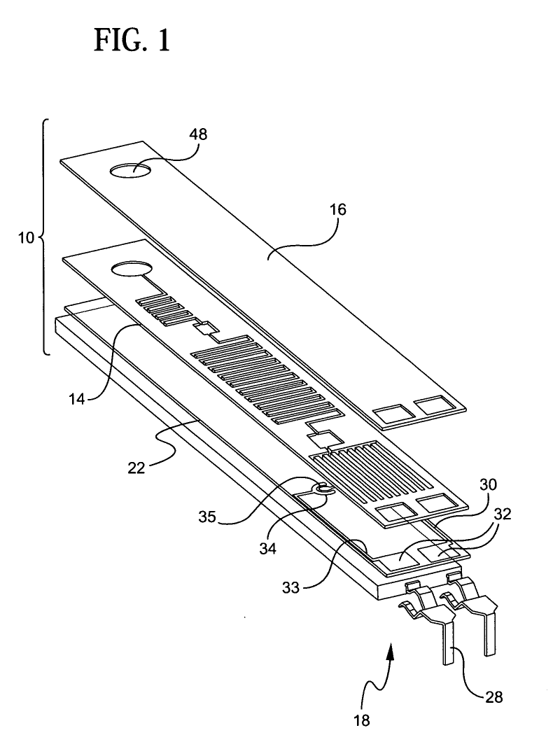

Referring to the accompanying drawings wherein like reference numbers refer to the same or similar elements, an embodiment of a microfluidic device in accordance with the invention is shown in FIG. 1 and designated generally as 10. Microfluidic device 10 includes a support 22, a photoresist layer 14 arranged above the support 22, a cover layer 16 arranged above the photoresist layer 14 and an electrical interconnection unit 18 arranged in connection with the support 22.

Support 22 forms or is part of a support structure for microfluidic device 10 which can take any form which provides a preferably rigid underlying substrate for the photoresist layer 14. The support structure can include a base, a substrate, and a layer of material, either alone or various combinations thereof. In the illustrated embodiment, the support structure includes a rigid backing substrate 20 which provides strength and rigidity to the microfluidic device 10 and the support 22 which is a first PET film 22 whose lower surface is directly bonded to or otherwise attached to the upper surface of the backing substrate 20. In one preferred aspect of the invention, the support 22 is a non-conductive polymeric film. A non-limiting list of the support is selected from the group consisting of poly-ethylene terephthalate (PET), polyethylene (PE) and polycarbonate. The support is preferably PET. Backing substrate 20 may be made of polypropylene, polycarbonate or polystyrene plastic card. Those in the art can appreciate other available backing substrates to provide strength and rigidity.

Photoresist layer 14 may be made of polyimide polymer and its bottom surface is directly bonded to or otherwise attached to the first PET film 22. A top surface of the photoresist layer 14 is directly bonded to or otherwise attached to the cover layer 16. In a preferred embodiment, the photoresist layer 14 is a dry photoresist film, e.g., DuPont RISTON®, Pyralux PC1025, Pylalin PI2721 or SU-8 coated film. Dry polyimide photoresist films, such as RISTON® from DuPont, are widely used for printed circuit board production in the electronics industry. Dry photoresist film is easily dissolved in weak alkaline solution. However, upon exposure to UV radiation, the photoresist film undergoes polymerization and becomes resistant to dissolution in alkaline solution. In addition, once the photoresist film has been polymerized, it is stable in aqueous solution and it possesses good wetting properties. Such dry photoresist materials are therefore uniquely suited for the formation of channels, chambers, and other structures as discussed below.

Cover layer 16 may be a second PET film. The cover layer 16 can be a polymeric film or adhesive film. The cover layer 16 may be transparent or translucent. It is advantageous for the cover layer 16 to be transparent when fluorescent or optical detection method is used. A non-limiting list of the cover layer 16 is selected from the group consisting of PET, polyethylene (PE), polycarbonate, wet polyimide film or adhesive film. Cover layer 16, as well as the other cover layers in microfluidic devices disclosed herein, is also referred to herein simply as a cover.

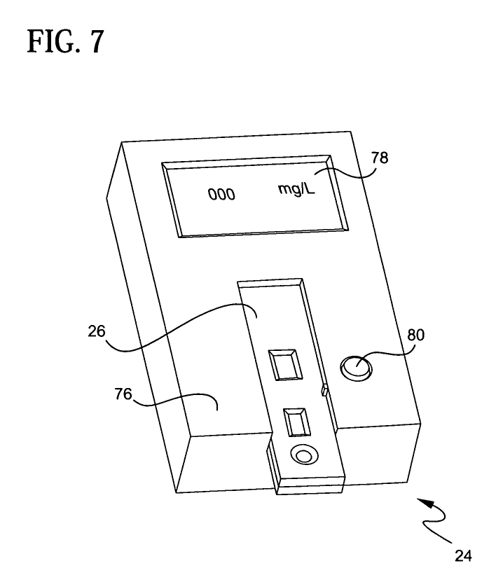

In some preferred aspects of the invention, electrical interconnection unit 18 is designed to electrically connect a region of the photoresist layer 14 (the specific region is discussed below) to a reading unit 24 which engages with a housing 50 in which the microfluidic device 10 is enclosed (see FIG. 7). Electrical interconnection unit 18 includes electrodes 30 and 33. Electrical interconnection unit 18 further comprises a pair of, for example, substantially L-shaped connector pins 28 made of an electrically conductive material. Electrodes 30 and 33 are formed on or in connection with the first PET film 22 by a known manufacturing process, such as photolithography, screen printing or sputtering method. For example, part of the electrodes 30 and 33 comprise the form of a metallic film which is photolithographically patterned around a designated part of the photoresist layer 14 and leads extending from this metallic film to the pins 28. Preferably, the electrodes 30 and 33 are directly bonded to the upper surface of the first PET film 22.

The conductive or metallic materials used in the electrical interconnection unit 18 may be gold, indium tin oxide (ITO), silver, platinum, palladium either individually or mixtures thereof. When microfluidic device 10 is used for fluorescent or optical detection, electrical interconnection unit 18 is unnecessary.

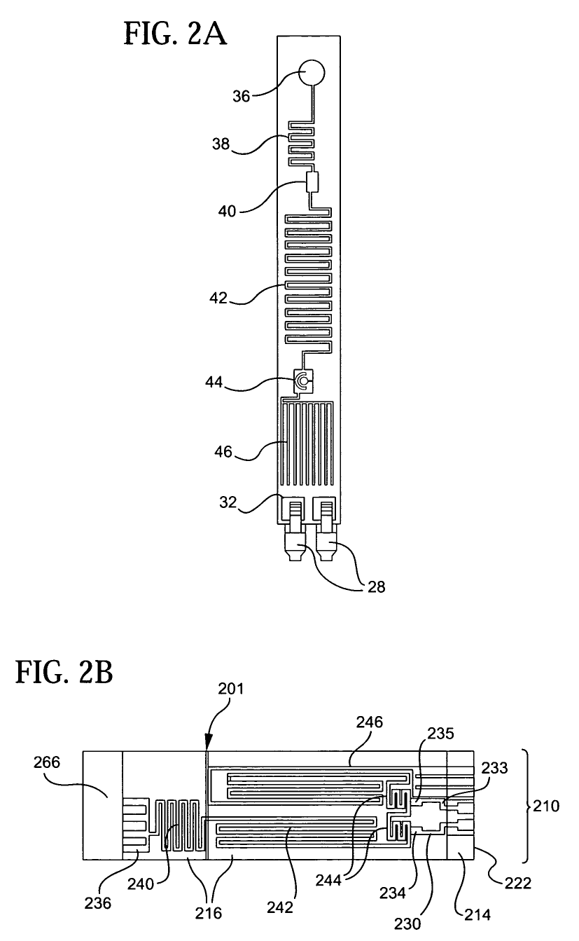

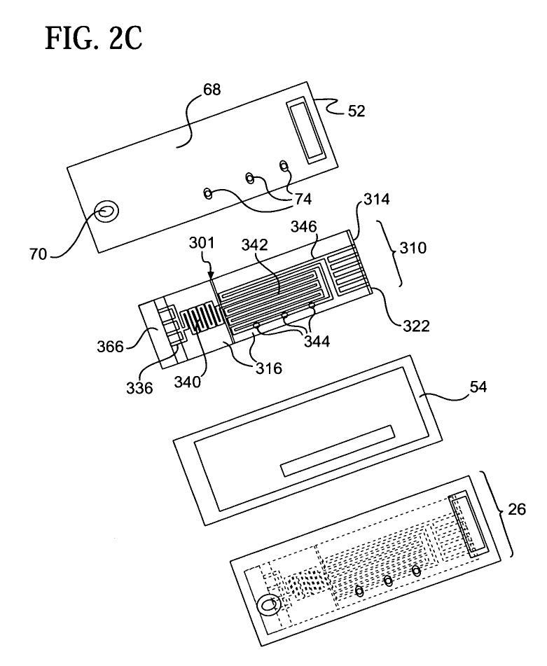

In one exemplifying construction of the invention, electrodes 30 and 33 are substantially U-shaped and have an electrode pad 32 at one end which is in direct contact with a respective connector pin 28. At an area opposite the pads 32, working portions 34 and 35 of the electrodes 30 and 33 are below a designated part of the photoresist layer 14. It should be understood that the shapes of the pads 32 and working portions 34 and 35 are one example and are not limited to that particular shapes in FIG. 2A. Cover layer 16 has apertures aligning with the pads 32. The apertures in photoresist layer 14 and cover layer 16 preferably allow a portion of the electrodes 30, 33 to be exposed to allow for contact with the connector pins 28 as shown in FIG. 2A. One of the electrodes 30, 33 is to perform as a working electrode and the other as a reference electrode, the use of which is well appreciated by those skilled in the art.

Electrodes may be made of any electrically conductive material, including but not limited to, gold, indium tin oxide, silver, platinum, palladium and combinations of these materials.

In one example of connector pins 28, connector pins 28 have separated flanges which engage with opposite sides of the support PET film 22 and the backing substrate 20 to press the pads 32 against the backing substrate 20 and thereby provide for a secure electrical connection between the connector pins 28 and the pads 32. Alternative electrical engagement mechanisms which create an electrical path from the pads 32 to pins can be used in the invention without deviating from the scope and spirit thereof.

In an exemplifying construction of microfluidic device 10, the thickness of the cover and support PET films 16 and 22 is approximately 100 μm thick. The thickness of the photoresist layer 14 is from about 25 to about 100 μm, and is preferably, approximately 50 μm thick. As such, one preferred microfluidic device 10 has a thickness of about 250 μm above the backing substrate 20. The thickness of the electrodes 30, 33 is preferably less than 50 μm and should be less than that of the photoresist layer 14 in microfluidic device 10. The thickness of the electrodes 30, 33 can be more preferably from about 2 to 20 μm. When the electrode material is ITO, the electrode can be as thin as 2 μm.

FIGS. 2B and 2C illustrate alternative construction of microfluidic devices.

Referring to FIG. 2B, microfluidic device 210 includes a support 222, a photoresist layer 214 arranged above the support 222, a cover layer 216 arranged above the photoresist layer 214 and an electrical interconnection unit 218 arranged in connection with the support 222.

Alternatively, the cover 216 consists of two sheets having a junction gap 201 between the two sheets. The junction gap 201 is similar to the delay channel 38 in FIG. 2A serving to incorporate a delay or time-lag into the analyte testing, and is useful for flow stabilization. The junction gap is, however, not too wide to cause leakage of sample fluid. Reaction region 240 is placed within a channel connecting a sample inlet 236 and a mixing region 242.

Electrical interconnection unit 218 includes electrodes 230 and 233. At one end of each of the electrodes 230 and 233, working portions 234 and 235 of the electrodes are below a designated part of the photoresist layer 214 which defines the detection chamber 244.

The length of cover layer 216 is less than of the photoresist layer 214 and thus, a portion of the electrodes is exposed to allow for contact with the connector pins (not shown in this embodiment but which may be the same as described above). Open ends of a set of an absorbent channel form air vents. The length of the cover layer 216 at the electrode pads is preferably, slightly less than the photoresist layer 214 and favorably allows air vents.

Referring to FIG. 2C, microfluidic device 310 includes a support 322, a photoresist layer 314 arranged above the support 322 and a cover layer 316 arranged above the photoresist layer 314. Microfluidic device 310 includes a junction gap 301 between the two sheets of the cover layer 316. In some preferred aspects of the invention, a microfluidic device allows multiple analytes to be tested simultaneously. Such a microfluidic device may include two or more detection chambers or regions. In one preferred exemplifying construction, microfluidic device 310 contains three detection chambers or regions 344 (see FIG. 2C). One of the three detection chambers may be for a reference and the others for analytes to be analyzed. Each detection chamber 344 can include a different substance bonded to the metallic film or polymeric film. Hydrophobic and electrostatic interactions between the substance and the metallic film or polymeric film are enough to prevent the substance from being washed and flowing to absorbent channels. Alternatively, the substance can be bonded to the metallic film or polymeric film coated with self-assembled monolayer such as polypyrrole, sulfonated tetrafluorethylene copolymer (NAFION®), alkoxysilane or mixtures thereof. These self-assembled monolayers (SAM) enhance the binding efficiency and strength. The substance is preferably bonded to the self-assembled monolayer coating the metallic electrode, ITO or polymeric film. To immobilize antibodies or capture molecules on the metallic electrode or polymeric film in the detection chamber, the surface of the metallic electrode or polymeric film may be modified with self-assembled monolayers (SAM) or by hydrophobic polymer printing. The SAM is a unidirectional layer formed on the surface caused by spontaneous aggregation of SAM-forming molecules.

Thiol-containing SAM-forming molecules are one of the well-established binding molecules to gold. Carboxyalkanethiol compounds and succinimidyl alkanedisulfide compounds (succinimidyl ester-terminated alkyldisulfides) are widely utilized for forming SAM on the gold surface to introduce carboxylic groups or amine reactive sites. Succinimidyl ester-terminated alkyldisulfides are amine-reactive analogs of carboxyalkyldisulfide. The carboxyl groups of carboxyalkanethiols are converted to activated N-hydroxysuccinimide ester to bind to amines of antibodies or capture molecules. The surface coated with SAM does not require any other coupling agents to immobilize antibodies or capture molecules. The SAM-forming molecules are applied on the surface of the gold electrode or polymeric film by spotting and drying process.

The cover layers 216, 316 in the embodiments shown in FIGS. 2B and 2C form junction gaps 201, 301 which provide for flow time delays between the reaction chamber 240, 340 and mixing channel 242, 342, respectively.

Referring now to FIG. 2A, the photoresist layer 14 has a unique structure which provides for a simple and efficient analyte testing. Specifically, when formed in a manner described below, the photoresist layer 14 is provided with a distinctive pattern of chambers and channels which cooperate to allow for an expeditious analyte testing. FIG. 2A shows an exemplifying pattern wherein the photoresist layer 14 includes an inlet chamber 36 at one end, a delay channel 38 connected to the inlet chamber 36, a reaction chamber 40 connected to the delay channel 38 and which contains a reagent mixture including a first analyte binding substance, a mixing channel 42 connected to the reaction chamber 40 which also preferably contains the first analyte binding substance, a detection chamber 44 connected to the mixing channel 42 and a set of absorbent channels 46 connected to the detection chamber 44. Although shown in a linear fashion, the various chambers and channel can be positioned in other arrangements, including in a non-linear arrangement. The set of absorbent channels 46 may contain only a single channel or a plurality of channels, examples of which are discussed below and also shown in FIGS. 2B and 2C.

Inlet chamber 36 is that part of the photoresist layer 14 into which a fluid to be tested is placed. Cover layer 16 is provided with an aperture 48 aligning with the inlet chamber 36 in order to avoid inhibiting the flow of fluid into the fluid chamber (see FIG. 1).

Delay channel 38 serves to incorporate a delay or time-lag into the analyte testing, and is also useful for flow stabilization, i.e., stabilizing the flow of the sample fluid. Delay channel 38 is formed from a series of transverse sections and longitudinal sections connecting adjacent transverse sections to thereby form a meandering path.

Mixing channel 42 is formed from a series of transverse sections extending across a substantial portion of the width of the photoresist layer 14 and longitudinal sections connecting adjacent transverse sections to thereby form a meandering path.

The working portions of the electrodes 34 and 35 are arranged in or form at least a part of the detection chamber 44. Thus, the part of the photoresist layer 14 aligning with the working portions 34 and 35 is the detection chamber 44.

The set of absorbent channels 46 includes elongate longitudinal sections and a transverse distribution section extending across the upper ends of the longitudinal sections. An inflow section from the detection chamber 44 leads to an intermediate location on the transverse distribution channel.

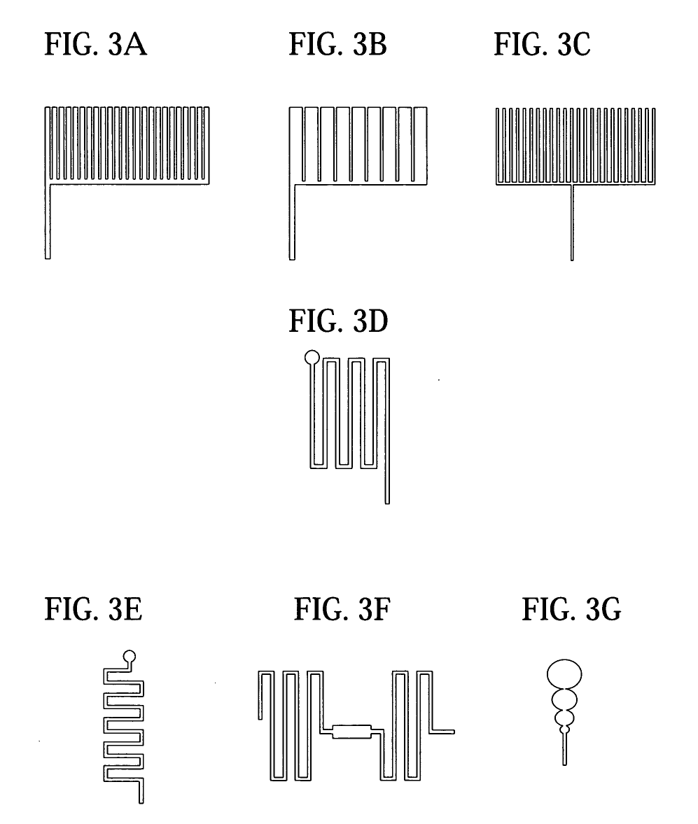

Variations in the set of absorbent channels 46 are shown in FIGS. 3A, 3B, 3C. Depending upon, for example, the particular test being performed, the width and length of the channels and the volumes of chambers may be varied. In a test that requires washing process, the absorbent channel volume should preferably be larger than the total volume of other part of channel and chamber, preferably about three times larger than the volume of the other part of the channel.

The width of microfluidic channels 38, 42 and 46 may vary from about 50 microns to about 1000 microns and is preferably from about 50 microns to 500 microns, and more preferably about 300 microns. The height of the channel may vary from about 25 microns to about 300 microns and is preferably about 50 microns

The channels 38, 42, 46, as well as the chambers 36, 40 and 44, are defined by parts of the support 22 (the bottom of the channels and chambers), parts of the photoresist layer 14 (the walls of the channels and chambers) and parts of the cover layer 16 (the top of the channels and chambers). Laminating the support 22, the photoresist layer 14 and the cover layer 16, e.g., in the manner described below, provides for a well-defined flow path through the microfluidic device 10.

The intermediate layer 14 is a dry photoresist film that provides the precisely defined micro fluidic channel structure. The intermediate film comprises a negative photoresist material with a typical thickness of 50 micron. The film uncovered with a mask is polymerized under a strong UV light resulting in an insoluble polymer film. Masked areas of the film are easily etched away by a spray of an alkaline solution. The surface of the polymerized, hardened film is hydrophilic, a benefit of this device.

In FIGS. 3A, 3B and 3C, the set of absorbent channels 46, 246 and 346 includes elongate longitudinal sections and a transverse distribution section which extends across the upper ends of the longitudinal sections. The inflow section leads from detection chamber 44 to the transverse distribution channel.

In FIGS. 3D and E, the set of reaction channels includes a single channel having a series of elongate longitudinal sections and short connecting transverse sections to thereby form a meandering path.

In FIG. 3G, the set of channels includes a series of oval sections to adjust flow speed of sample solution.

In FIG. 3F, the set of channels having a series of longitudinal sections and connecting transverse sections to thereby form a meandering path, with an enlarged chamber being formed in the middle of the channel.

As shown in FIG. 2A, the reaction chamber 40 and detection chamber 44 have substantially rectangular configurations. Alternatively, these chambers can be formed as shown in FIG. 3G as a progression of increasing diameter circular regions. Air is released from the chambers and channels in the photoresist layer 14 through air vent areas connected to the detection chamber 44 and/or the set of absorbent channels 46. Open ends of one or more of the absorbent channels 46 may form or include air vent areas.

Microfluidic device 10 would typically be installed into a housing, for example, made of plastic, to thereby form a complete robust rapid assay kit. At a minimum, the housing must allow for insertion of a fluid to be tested into the inlet chamber 36 and preferably visualization of the detection chamber 44 (to ensure that at least a portion of the fluid being tested has reached the detection chamber 44). Such housing can take multiple forms.

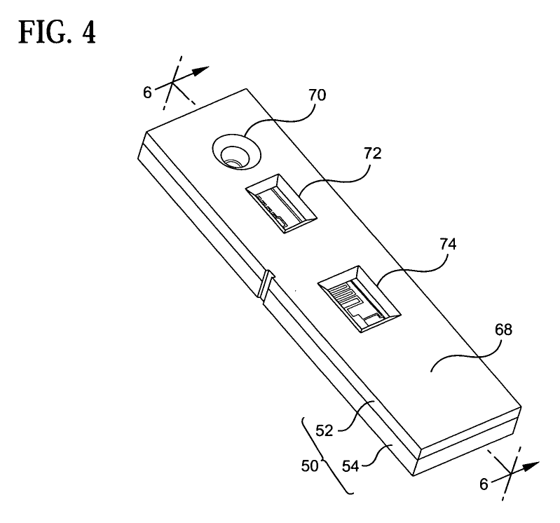

One such housing is shown in FIGS. 4-6, wherein the microfluidic device 10 is placed into housing 50 which has an upper housing part 52 and a lower housing part 54. Lower housing part 54 includes a planar base 56, a peripheral wall 58 extending upward from the base 56 and defining a recessed area 60, and positioning ridges 62 formed an on inner surface of the base 56 and spaced apart from one another to accommodate the backing substrate 20 therebetween. Lower housing part 54 also includes a mating structure 64 to enable it to engage with a complementary mating structure on the upper housing part 52, e.g., apertures in the upper housing part 52.

Lower housing part 54 is also formed with a pair of apertures (not shown) in the base 56 through which the connector pins 28 extend to the exterior of the housing 50 in order to enable electrical interconnection to electrical contacts on the reading unit 24 (shown FIG. 7). Instead of L-shaped pins 28, pins 28 can be constructed without a perpendicular bend and thus would extend directly away from the microfluidic device 10 in which case, apertures for passage of these pins to the exterior of the housing 50 would be provided in one or both of the lower and/or upper housing parts 52, 54. In the kit 24, those skilled in the art will appreciate that alternative electrical contacts on the reading unit 24 can be used in the invention without deviating from the scope and spirit thereof.

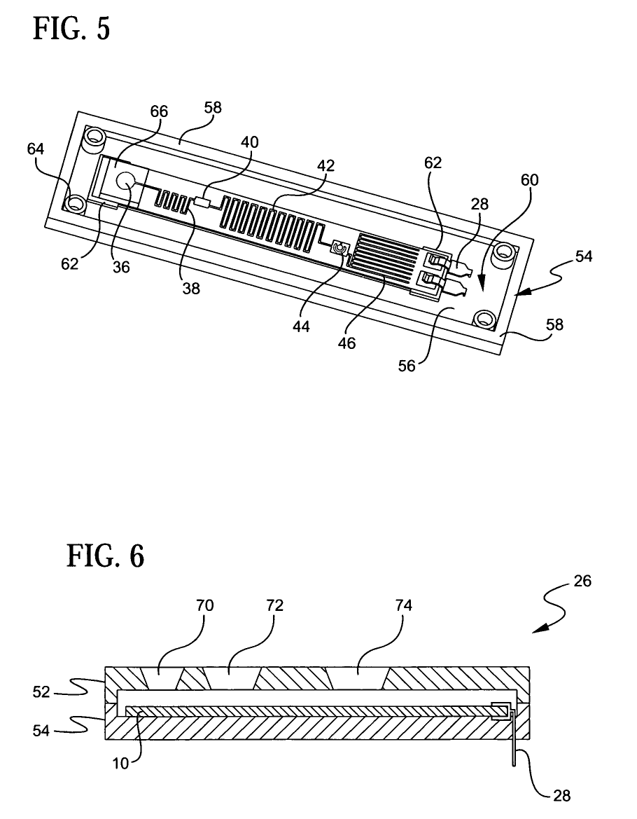

Prior to engagement of the upper and lower housing parts 52, 54 together to housing 50, a filter 66 is placed over the inlet chamber 36 to filter the fluid being tested (see FIG. 5). Filter 66 (and filters 266, 366) is constructed to remove any particles that may cause interference of binding signal generation or blockage of the microfluidic channels in the photoresist layer 14.

Upper housing part 52 includes a substantially planar base 68 having a sample well 70 aligning with the aperture 48 in the cover layer 16 and thus the inlet chamber 36. Base 68 may include a detection chamber window 74 which is positioned to align with the detection chamber 44. Base 68 can further include a reaction chamber window 72 which is positioned to align with the reaction chamber 40. To enable the reaction chamber 40 and detection chamber 44 to be viewed through windows 72, 74, the cover layer 16 could be made of a transparent material. In some preferred aspects of the invention, the transparent cover 16 and detection chamber windows 74 are advantageous when a fluorescent or optical detection method is used. The wetting of the dried reagent may be monitored at the reaction chamber window 72 and a visual inspection of the detection chamber 44 may be made through the detection chamber window 74.

In the embodiments where more than one detection chamber is presented, e.g., FIG. 2C wherein three detection chambers 344 are provided, the base 68 preferably includes a detection chamber window for each detection chamber 344 as shown in FIG. 2C.

Use of the kit 26 as a test for an analyte having one or more epitopes to which binding substances may bind where substance binding to the first epitope does not prevent substance binding to the second epitope will now be described. A sample of a liquid to be tested is obtained and placed into the sample well 70, onto the filter 66, so that it flows through the filter 66 into the inlet chamber 36. The liquid sample is drawn from inlet chamber 36 through the delay channel 38 to the reaction chamber 40 and interacts with the first analyte binding substance in the reaction chamber 40. The first binding substance is placed in or on the reaction chamber 40. As the liquid sample wets the reagent mixture in the reaction chamber 40, analyte reacts with the first analyte binding substance forming a first analyte-binding substance complex, the first analyte binding substance binding to a first epitope of the analyte. From the reaction chamber 40, the liquid sample then flows into the mixing channel 42 in which any unreacted analyte is contacted with a first analyte binding substance. Upon exiting the mixing channel 42, the liquid sample enters the detection chamber 44. The second analyte binding substance on the working portion of the working electrode in the detection chamber 44, binds a second epitope of analyte, thereby capturing the complex of first analyte binding substance and analyte.

As liquid sample continues to flow, it exits from the detection chamber 44 and enters into the set of absorbent channels 46. Unbound protein, complexes, reagents and other components of the liquid sample flow through the detection chamber 44 into the set of absorbent channels 46. Once the set of absorbent channels 46 is filled, the flow of liquid sample ceases.

Binding of the first analyte binding substance-analyte complex to the second analyte binding substance captures the complex. Binding of the complex to the second analyte binding substance changes the capacitance, impedance, resistance or current of the electrode 30 and (electrical status change). The magnitude of the electrical status change on electrode is related to the degree of binding and therefore related to the amount of analyte present in the liquid sample. Since electrodes 30 and 33 are in electrical contact with the pads 32, which in turn are in electrical contact with the connector pins 28, the difference in the magnitude of the electrical status change between the working electrode and the reference electrode is measurable by connecting a capacitance, impedance or amperometer to the connector pins 28. Such an electrical detection reader is present in the reading unit 24 which includes a pair of electrical contacts for electrically connecting to the connector pins 28 and electrical interconnection structure for connecting these contacts to the detection reader. Those skilled in the art will appreciate that the kit 26 may include a calibration electrode.

A more specific use of the kit 26 would be as a proposed immunoelectrochemical assay device to show the performance mechanism of a one-step immunoassay device for Acute Myocardial Infarction test.

Chest pain may arise from a variety of causes, for example a heart muscle problem. When a small blood clot forms in a heart blood vessel, chest pain may occur. If the clot is dissolved, the pain disappears. If the clot persists, the blood vessel may become blocked and a portion of the heart muscle may be denied oxygen and nutrients. Dying heart muscle cells release Troponin I, therefore elevated levels of Troponin I often indicate a heart muscle problem. Checking the Troponin I level of a patient complaining of chest pain can therefore aid in the diagnosis of the problem. A microfluidic device of the invention can be used to construct a Troponin I test kit.

For such a test kit in which Troponin I is selected as the analyte, in the reaction chamber 40, dried anti-Troponin I antibody labeled with indicating molecules, mixed with detergents 0.01% of Tween 20, buffer reagent 10 mM of sodium phosphate pH 7.2 and a stabilizer 0.5% trehalose, 0.5% BSA and 0.5% PEG is deposited. In the detection chamber 44, the second anti-Troponin I antibody is immobilized on the surface of electrode by covalent or noncovalent bonding and will bind with a different epitope of the Troponin I. A second anti-Troponin I antibody is diluted to a concentration of 30 μg/ml-3 mg/ml in 10 mM phosphate buffer containing 0.5% BSA. The second anti-Troponin I antibody solution is spotted on the surface of the electrode in the amount of 50 μl-100 μl per cm² and is dried at 25° C. and 40% humidity for 1 hour.

During use, when approximately 5-10 microliters of whole blood sample fluids containing Troponin I is placed in the sample well 70, the plasma sample fluids pass through blood separation filter 66 into inlet chamber 36 and flow through delay channel 38 to the reaction chamber 40. As the plasma wets the dried reagents in the reaction chamber 40, the Troponin I antibody and the Troponin I forms an antigen-antibody complex and flows into the mixing channel 42. Any unbound antibody is bound to Troponin I molecules with the aid of the mixing effect in the mixing channel 42. In the detection chamber 44, a second Troponin I antibody is immobilized on the surface of the electrode and will bind with a different epitope of the Troponin I. When the fluid passes into the detection chamber 44, the antigen-antibody complexes bind to the second antibody therein. The unbound complexes and other substances are washed away with the continuous stream of the sample fluid. The sample fluid enters the set of absorbent channels 46 until the set of absorbent channels 46 is filled with plasma. Then, the sample fluid flow stops and the immunochemical reaction stabilizes in the detection chamber 44.

The amount of the captured antigen-antibody complex on the electrode surface is related to the capacitance or voltage change of the working electrode 30. When the antigen-antibody complex is captured, it causes a slight change of the capacitance of the electrode 30. The capacitance change may be measured with a capacitance meter when the rapid assay kit 26 is inserted into a reading unit 24. Reading unit 24 is designed to covert the electrical status change into a reading indicative of the presence of amount of Troponin I antigens.

The foregoing is only a single example of a use of the kit 26 including microfluidic device 10 in accordance with the invention. Other detection methods which can be implemented using kit 26 with microfluidic device 10 include fluorescence, optical coloring, amperometric, ampedance/potentiometer and particle assay.

For fluorescence detection, the deposited reagents in the reaction chamber 40 are binding substances, i.e., antibodies or antigens coupled with fluorescence dye or particles such as quantum or europium. The binding substances immobilized in the detection chamber 44 are capture antibodies or antigens. For optical coloring, the deposited reagents in the reaction chamber 40 are antibodies or antigens coupled with oxidation or reduction enzyme. For amperometric detection, the deposited reagents in the reaction chamber 40 are antibodies or antigens coupled with horseradish peroxidase (HRP) enzyme and glucose as a substrate. The materials immobilized in the detection chamber 44 are capture antibodies or antigens, and glucose oxidase on the electrode 30. Antibodies or antigens coupled with alkaline phosphatase (APase) enzyme can be deposited in the reaction chamber 40. Other variations of the above are contemplated and well understood by those skilled in the art.

For impedance/potentiometer uses, there are no deposited reagents in the reaction chamber 40. The binding materials immobilized on the electrode 30 are capture antibodies or antigens. In this case, the delay channel 38 and reaction chamber 40 can be eliminated. Those skilled in the art will appreciate that binding substances in the reaction chamber 40 and detection chamber 44 can be one or more biogenic or immunoreactive substances capable of forming a complex, such as antibody/antigen, antibody/hapten, enzyme/substrate, reporter/hormone, nucleotide/nucleotide.

When microfluidic devices 10 in accordance with the invention are used for optical coloring or amperometric detection methods, the active substrate hydrogen peroxide for HRP enzyme is generated by coimmobilized glucose oxidase on the conductive surface of the electrode 30 with capture antibody. The glucose and HRP-conjugated antibody is placed in dry form in a location at the front of the reaction chamber 40 where the binding reaction occurs. Sample solutions will solubilize the dried reagents and move them to the reaction chamber 40. To increase the binding sensitivity, streptavidine or avidine might be immobilized on the electrode instead of a capture antibody. In this case the HRP-conjugated antibody and second capture antibody coupled with biotin is placed at the reaction chamber 40.

The detection methods discussed above are merely exemplifying detection methods and their mention does not limit the scope of invention but simply provide examples of currently preferred embodiments of the invention.

As shown in FIG. 7, reading unit 24 is designed to read an electric signal when the assay kit 26 is inserted into a slot therein. Reading unit 24 includes a housing 76 defining the slot, a display 78, a button 80 and a processor or microcontroller arranged in the housing 76. Reading unit 24 also includes electrical contacts designed to engage with the pins 28 and connect to the microcontroller to enable the formation of a circuit including the electrodes 30 and 33. Upon insertion of the assay kit 26 into the slot defined by housing 76, the button 80 is pressed to direct the microcontroller to form the circuit including electrodes 30 and 33 and detect the electrical status change. The electrical status change is correlated with the assay result which is displayed on display 78. More specifically, the microcontroller in the reading unit 24 produces a digital signal when the kit 26 is placed in contact with the contacts of the reading unit 24 and the button 80 is pushed by the user. The reading unit 24 may be calibrated to produce displayed results meaningful to users of the system.

Depending on the substances, if any, arranged in the reaction chamber 40, if present, and the detection chamber 44, and the construction of the reading unit 24, the microfluidic devices 10 in kits 26 in accordance with the invention may be used in the following types of assays:

1. Drug Abuse assays for analytes such as heroin, morphine, cocaine, LSD, amphetamines, PCP, THC, barbiturates, and other sedatives, narcotics, and hallucinogens.

2. Infectious disease assays, such as Streptococcus A, HIV, Hepatitis A, B and C virus, H. pylori, Mononeuclosis, Chlamydia, Gonorrhea and other STDs.

3. Therapeutic Drug Monitoring

4. Reproduction related testing including hCG, FSH, and LH

5. Diabetes testing, such as monitoring glucose, Hb1Ac levels in blood

6. Cardiac markers, such as CK MB, Troponin, Myoglobin, BNP, pro BNP, hCRP, D-dimer, homocystein

7. Cholesterol monitoring, such as HDL, LDL, and ApoLP

8. Blood Coagulation Testing

9. Cancer Markers, such as CEA, AFP, PSA, BladderCa (BTag)

10. Osteoporosis monitoring such as bone resorption testing

11. Mental Disorders, such as Alzheimers disease test detecting isoprostane, and neural thread protein

12. DNA diagnostics for genetic testing using micro array and PCR devices

13. Allergy testing

14. Urine analysis

15. Blood Gas/Electrolyte

16. Animal health testing

Microfluidic device 10 can be manufactured in a variety of ways. One non-limiting manufacturing method is to first select a support 22, such as a PET film, then print electrodes 30, 33 on the PET film, cover the electrodes 30, 33 printed PET film with a polyimide photoresist film, such as DuPont RISTON® to be used to form photoresist layer 14, then cover the photoresist film with a protective covering with a photomask which has an outline of a pattern of channels and chambers, polymerize the photoresist material through exposure to UV light, remove the protective covering, wash away the unexposed, masked photoresist film with alkali solution, apply any necessary reagents, and cover the photoresist layer 14 with a cover layer 16. The cover 16 is a nonconductive polymeric film. An adhesive film can be used as the cover layer 16 securing the photoresist layer 14.

The cover layer 16 may be a second photoresist film having its protective cover removed, and which is placed in direct contact with the first photoresist layer. The second photoresist layer is bonded to the first photoresist layer, for example, upon application of heat. During the laminating process, temperatures within a range of about 45° C. to about 110° C. may be used, preferably about 90° C. Heat exposure times may vary depending on sizes of heat pressure rollers within a range of from about 5 seconds to about 500 seconds, preferably less than about 30 seconds, most preferably only about 7 seconds. Following bonding of the photoresist layers, the assembly is exposed to further UV radiation to insure complete polymerization of the polyimide photoresist polymers. The laminating process for manufacturing the microfluidic device 10 is well known in the art.

Thereafter, the remaining parts of the microfluidic device 10 are attached to the support 22. The microfluidic device 10 can then be installed into a housing 50 to form a rapid assay kit 26.

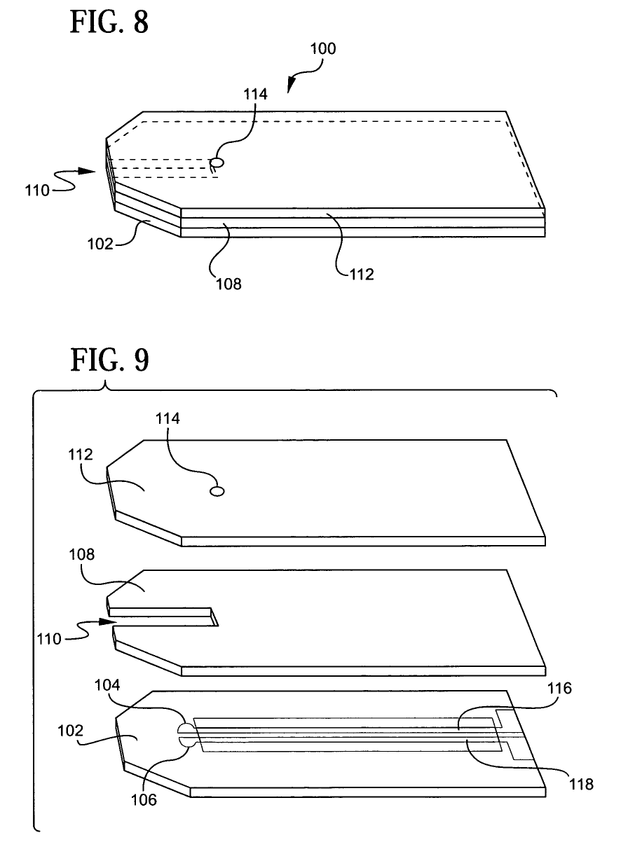

Referring now to FIGS. 8-14, FIGS. 8 and 9 show an alternative exemplifying design of an electrochemical sensor device 100 in accordance with the invention which enables amperometric or potentiometric electrochemical detection. Electrochemical sensor 100 is designed to detect a product resulting from a chemical or enzymatic reaction of an analyte. The electrochemical sensor device 100 does not require that an analyte tested be separated from other unbound ligands by washing. The device performs a chemical or enzymetical reaction assay, separation-free.

Electrochemical sensor device 100 includes a bottom support layer 102, on which a reference electrode 104 and working electrode 106 are arranged, an intermediate photoresist layer 108 defining an inlet channel 110 and detection chamber aligned with the reference electrode 104 and working electrode 106, and a cover layer 112 defining an air vent aperture 114.

Inlet channel 110 is connected to detection chamber aligned above the reference and working electrodes 104, 106 so that a product generated by a chemical or enzymatic reaction of an analyte, when present in detection chamber, affects the current transmission of the electrodes 104, 106.

Reference electrode 104 and working electrode 106 may be fabricated from an electrically conductive metal and/or carbon and are connected to pre-printed ITO, carbon, or conductive metal circuits 116 and 118 which are engaged with connector pins of a reading unit 24 (not shown). Usually the reference electrode 104 includes Ag/AgCl, and the working electrode 106 includes gold, ITO or carbon. So that a portion of the metal circuits 116, 118 is exposed to allow for contact with the connector pins of the reading unit 24, the length of the intermediate photoresist layer 108 and cover layer 112 are slightly less than the length of the bottom support layer 102.

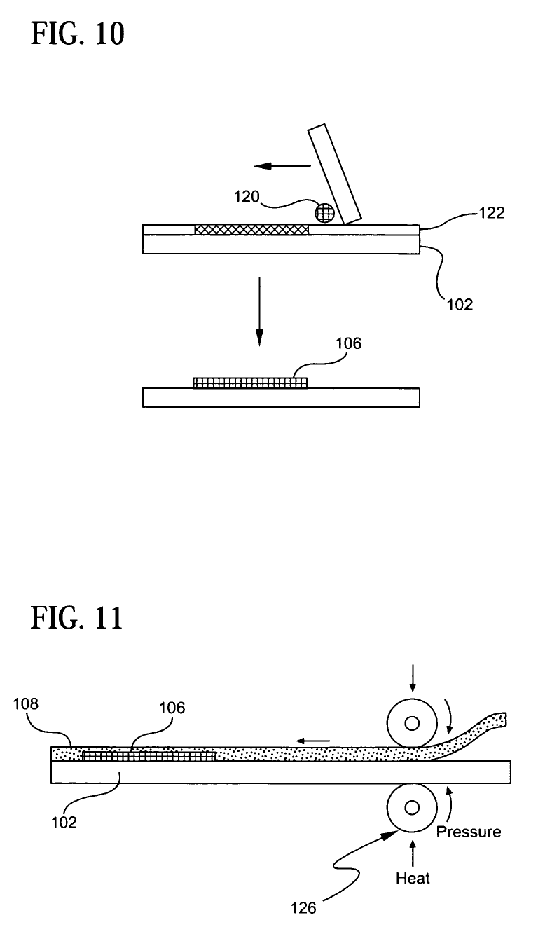

FIGS. 10-13 show one manner to manufacture the electrochemical sensor device 100 described above, which may also be used to manufacture microfluidic device 10. The various steps in the manufacture process include screen printing, sputtering for depositing the electric sensor, photolithography, and chemical etching and laminating with heat pressure method for micro fluidic fabrication. The first step is printing or sputtering reference electrode 104 and/or working electrode 106 on the support layer 102.

FIG. 10 shows an example of electrode-printing method using screen mesh having electrode mask. Paste or liquid state conductive material 120, such as gold, silver, carbon or the like, are placed on a mesh screen 122. Mesh screen 122 is thinner than the photoresist film 108. The thickness of mesh screen 122 is less than about 50 μm, preferably from about 5 μm to about 20 μm, more preferably from about 8 μm to about 20 μm.

After printing electrode(s), the gold electrode-printed PET film plate is soaked in the modified Piranha solution for 10-15 min and washed with purified water. Since original Piranha solution is a strong oxidizing agent and may erode the polymeric film, the modified Piranha solution is used. The Modified Piranha solution contains 1N sulfuric acid and 20% hydrogen peroxide in a ratio of 1:1. The self-assembled monolayer (SAM)-forming molecule solution is prepared in ethanol at a concentration of about 1 mM to 20 mM. The gold electrode-printed PET film plate is soaked in the solution for a period which varies depending on the concentration of the SAM-forming molecules and size of the treatment surface. When 2 mM N-succinimidyl hexanedisulfide solution is used, the period is between approximately 45 min to 2 hours. After the treatment, the SAM-coated plate is washed with ethanol and then water, and dried under nitrogen environment, if necessary.

In FIGS. 10 and 11, after printing the electrode(s) and metal circuits 104, 106, 116, 118 on the bottom support layer 102, dry photoresist film 108 is used to cover the support layer 102 with the electrode(s) and circuits 104, 106, 116, 118 and is laminated with a heat pressure roller 126 (see FIG. 11). Methods of printing the electrodes and circuits are well known in the art, for example by screen printing. Laminating temperatures depend on various factors, for example, the character of film materials, and are in the range of about 45° C. to about 110° C.

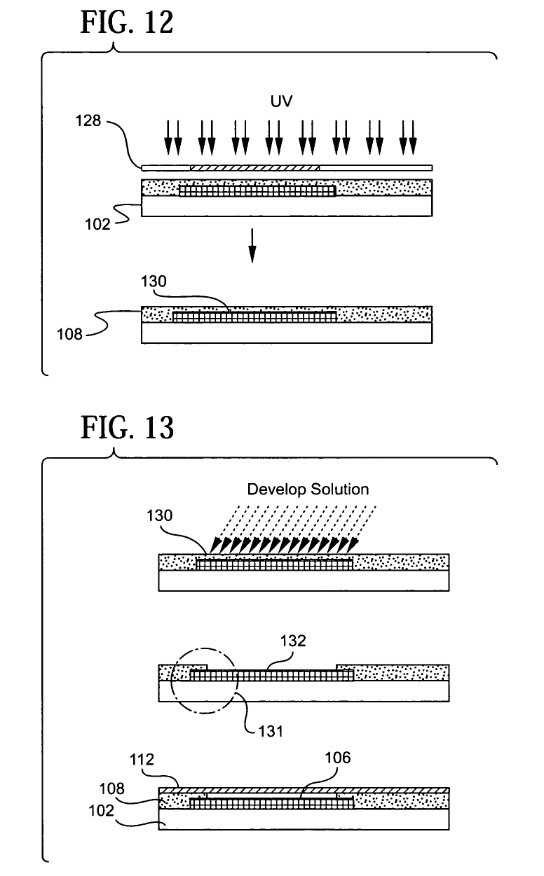

As shown in FIG. 12, before polymerizing the photoresist film 108, a photomask 128 film comprising the microfluidic channel design (black part) is placed in contact with the laminated assembly of the photoresist film 108 and bottom support layer 102. The photomask 128 should be positioned above the electrode(s) and circuits 104, 106, 116, 118, covering a portion thereof. The dry photoresist film 108 laminated on the support layer 102 is polymerized by UV illumination. Polymerization of the photoresist film 108 is induced by exposure to UV radiation for about 5 seconds to about 120 seconds with, for example, a 1 KW UV source. The time and radiation intensity are dependent upon various factors, such as the thickness of matrix, geometry of the channels to be formed in the photoresist film 108 and UV source. Exposure duration is preferably from about 20 seconds to about 80 seconds when 1 KW UV source is used. The polymerized area exposed to UV light forms the walls of the channel or channels and chambers in the photoresist film 108. The area 130 covered by photomask 128 unexposed by UV light, remains soft and labile.

As shown in FIG. 13, the next step is to contact the photoresist film 108 with alkaline solution (e.g., 0.1 M sodium carbonate buffer pH 9.2) to wash away the unstable, unexposed area 130 of photoresist film 108 and to thereby form a cavity or cell 132 in the laminated assembly. The resulting assembly is then covered by cover layer 112. Junction region(s) 131, namely walls of the channel(s), between the covered and exposed electrode(s) and circuits 104, 106, 116 118 are formed during manufacture of the electrochemical sensor device 100. Then the resulting assembly is covered with cover layer 112. A polymerized wet photoresist layer can be used as cover layer 112 which tightly seals the junction regions and prevents the sample liquid, when present in the inlet chamber 110 and detection chamber, from penetrating into junction region gaps. The electrochemical sensor device 100 is then finished to obtain the construction shown in FIG. 9.

The length of photoresist layer and cover layer 108, 112 is less than of the bottom support layer 102 and thus, a portion of each electrodes 104, 106 is exposed to allow for contact with the connector pins.

To make electrochemical sensor device 100, the enzyme and/or binding substance should be deposited on the surface of an electrode 104, 106 in alignment with the detection chamber before covering the inlet channel 110 with the upper cover layer 112. Either covalent or non-covalent binding can be applied to deposit the enzyme and/or binding substance on the electrode. Non-covalent binding comprises depositing the antibody or enzyme on the electrode. This step is spotting nano-liter to micro-liter scale volumes of the molecule solution onto the electrodes 104, 106 directly. Hydrophobic and electrostatic interactions occur between the molecules of proteins and electrodes 104, 106. The strength of the interactions is enough to keep the molecules from the washing flow in the detection chamber. To increase the binding efficiency and strength, the electrodes 104, 106 may be preferably coated with self-assembled monolayer materials such as polypyrrole, NAFION® or alkoxysilane. The protein molecules may be covalently bound to the electrodes through functional groups by chemical or photo activation.

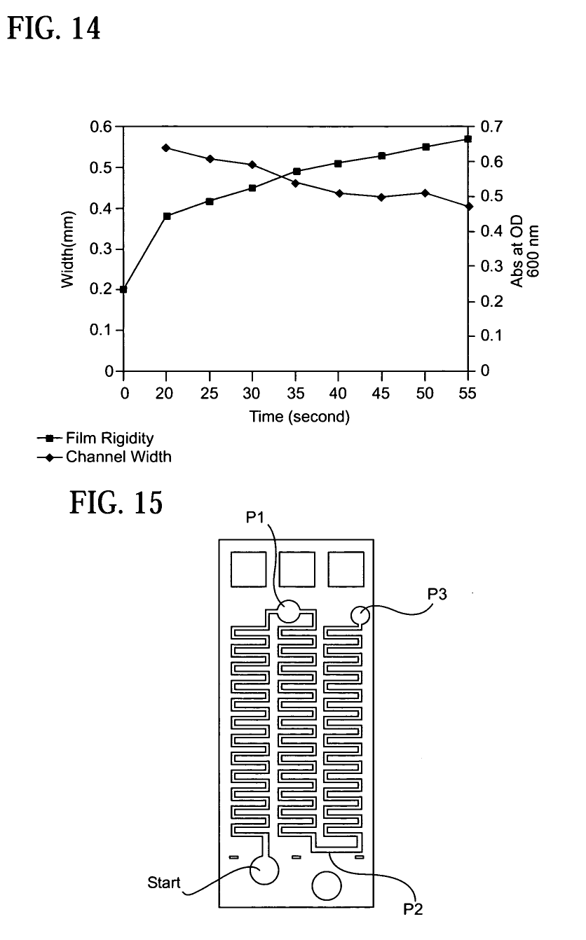

FIG. 14 is a graph showing the UV radiation times used to make channels having a width of about 500 μm width and a depth of about 50 μm. Specifically, this data is derived from manufacture of a microfluidic device in which a photoresist film with a 50 μm thickness was laminated on PET film with 100 μm thickness. This was then covered with a photomask comprising channels having a width of about 500 μm and exposed to UV light for from about 20 to about 55 seconds. The samples were removed at designated times and washed with carbonate buffer. The channel fabrication results were measured. The degree of polymerization was measured by blue light absorbance of the film using spectrophotometer at about 600 nm and the channel width was measures using calipers. The light absorbance of polymerized film at about 600 nm was increased but channel width is slowly decreased as exposure time increased. The color of polymerized photoresist films changes from light blue to dark blue according to the polymerization level.

Flow speed is one of the most important parameters which determine the resolution of analyte separation in chromatographic assays. Unlike membrane-based assays, the flow speed and capillary force may be controlled in microfluidic channel systems. The combination of different of widths and lengths of chambers and channels as shown in FIGS. 3A-3F allow the fabrication of many types of devices. When a channel having a larger cross-sectional area is used, the flow therethrough is greater than a channel with a smaller cross-sectional area. Thus, the width and depth of the channels in the photoresist layer 14, i.e., delay channel 38 and mixing 42, can be controlled to ensure adequate flow therethrough to the reaction chamber 40 and the detection chamber 44, respectively. To make microfluidic devices for immunochromatographic assays, the sample flow speed should be consistent and slow enough to allow for binding substances to react.

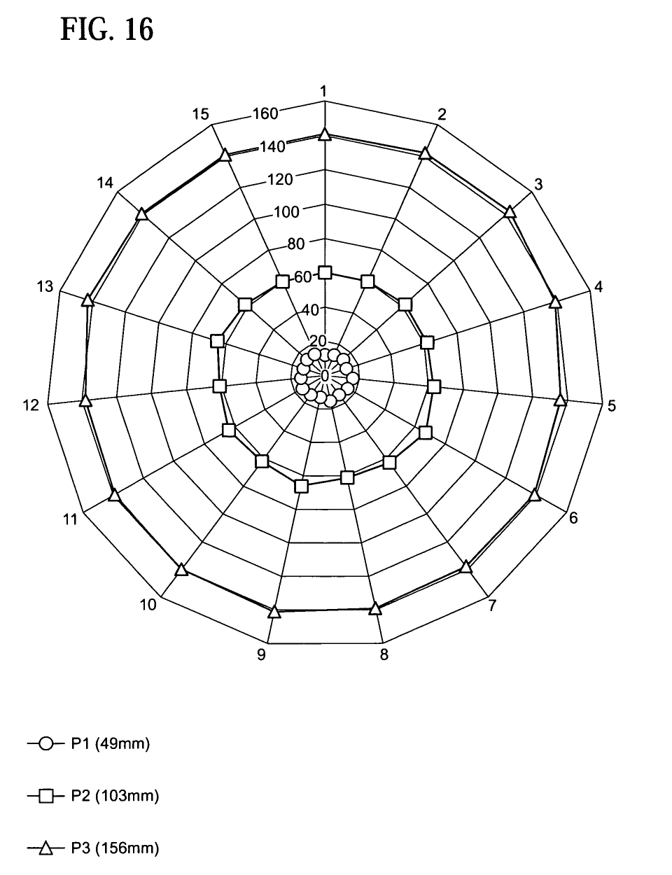

In FIGS. 15 and 16, fifteen microfluidic devices were tested. A 10 ul of color ink was loaded on the sample inlet and then the arrival time was measured at each designated point, P1-P3. The measured times were presented in a radial graph. The arrival times were in proportion to channel length. FIG. 16 shows that the microfluidic devices allow the consistent flow speed and migration length among 15 devices tested.

The ability to precisely determine the depth and width of the channels in the photoresist layer thus allows microfluidic devices in accordance with the invention to be used for quantitative assays as well as qualitative assays since they can be designed to provide a consistent flow speed and length of migration time.

When an electrochemical sensor device 100 in accordance with the invention is used for detecting small molecules such as oxygen, urea, drugs and glucose, the electrochemical sensor device 100 may not require a separation step (as is required for microfluidic device 10). The detection sensor is thus very simple and easy to use. Oxidation or reduction enzyme may be used in the electrochemical sensor device 100. One preferred example of the electrochemical sensor 100 is a glucose meter. A sample fluid including glucose to be analyzed is placed in the sample inlet 110, and flows into a detection region where glucose in the sample fluid contacts to glucose oxidase (GOD) immobilized in the detection chamber. Glucose oxidase generates hydrogen peroxide in proportion to glucose level in sample fluid. The resulting hydrogen peroxide affects current and variation in current is transmitted to reading unit 24 through the electrodes 104, 106.

1. A one-step microfluidic device, comprising:
a photoresist layer defining an inlet chamber adapted to receive a sample fluid to be tested, a reaction chamber in fluid communication with said inlet chamber, at least one detection chamber in fluid communication with said reaction chamber, and an absorbent chamber downstream of said at least one detection chamber in the direction of flow of the sample fluid;
a support structure arranged under said photoresist layer for providing rigid support for said photoresist layer; and
a cover arranged above said photoresist layer for covering said reaction chamber, said at least one detection chamber and said absorbent chamber,
wherein said absorbent chamber comprises at least one absorbent channel and said absorbent channel includes an open end; and
wherein the microfluidic device is capable of precise sampling.

2. The device of claim 1, wherein said absorbent chamber comprises a set of absorbent channels downstream of said at least one detection chamber in the direction of flow of the sample fluid.

3. The device of claim 2, wherein said absorbent chamber defines a single meandering channel.

4. The device of claim 2, wherein said set of absorbent channels defines a plurality of parallel channels communicating at an inlet end with a last one of said at least one detection chamber.

5. The device of claim 1, wherein said photoresist layer further comprises a delay channel interposed between said inlet chamber and said reaction chamber.

6. The device of claim 1, wherein said photoresist layer further comprises a mixing channel interposed between said reaction chamber and said at least one detection chamber.

7. The device of claim 1, wherein said at least one detection chamber consists of a single detection chamber.

8. The device of claim 1, wherein said at least one detection chamber comprises a plurality of detection chambers separated from one another.

9. The device of claim 1, wherein said support structure comprises a film layer.

10. The device of claim 9, wherein said support further includes a rigid backing substrate arranged under said film layer.

11. The device of claim 1, wherein said cover is transparent.

12. The device of claim 6, wherein said cover includes a junction gap interposed between said reaction chamber and said mixing channel.

13. The device of claim 1, further comprising one or more first biogenic or immunoreactive substances arranged in said reaction chamber and one or more second biogenic or immunoreactive substances arranged in each of said at least one detection chamber.

14. The device of claim 1, further comprising a conductive surface in or defining at least part of said at least one detection chamber.

15. The device of claim 14, wherein said conductive surface is an electrode.

16. The device of claim 14, further comprising one or more first biogenic or immunoreactive substances arranged in said reaction chamber and one or more second biogenic or immunoreactive substances arranged in connection with said conductive surface in or defining at least part of each of said at least one detection chamber.

17. The device of claim 14, further comprising an electrical interconnection unit having said conductive surface in or defining at least part of said at least one detection chamber and connector pins on opposite sides of said conductive surface, whereby particles in the sample fluid react with said conductive surface and cause a variation in current through said conductive surface which is detectable by forming a circuit with said connector pins.

18. The device of claim 16, wherein the one or more second biogenic or immunoreactive substances are bonded to said conductive surface.

19. A one-step microfluidic device, comprising:
a photoresist layer defining an inlet chamber adapted to receive a sample fluid to be tested, a reaction chamber in fluid communication with said inlet chamber, a mixing channel in fluid communication with said reaction chamber, at least one detection chamber in fluid communication with said reaction chamber, and a set of absorbent channels downstream of said at least one detection chamber in the direction of flow of the sample fluid;
a support structure arranged under said photoresist layer for providing rigid support for said photoresist layer; and
a cover arranged above said photoresist layer for covering said reaction chamber, said at least one detection chamber and said absorbent channels,
wherein said absorbent channels include open ends; and
wherein the microfluidic device is capable of precise sampling.

20. The device of claim 19, further comprising one or more first biogenic or immunoreactive substances arranged in said reaction chamber and one or more second biogenic or immunoreactive substances arranged in each of said at least one detection chamber.

21. A one-step microfluidic device, comprising:
a photoresist layer defining an inlet chamber adapted to receive a sample fluid to be tested, a reaction chamber in fluid, communication with said inlet chamber, a mixing channel in fluid communication with said reaction chamber, at least one detection chamber in fluid communication with said reaction chamber, and a set of absorbent channels downstream of said at least one detection chamber in the direction of flow of the sample fluid, wherein said at least one detection chamber further comprises a conductive surface in or defining at least part of said at least one detection chamber;
a support structure arranged under said photoresist layer for providing rigid support for said photoresist layer; and
a cover arranged above said photoresist layer for covering said reaction chamber, said at least one detection chamber and said absorbent channels,
wherein said absorbent channels include open ends; and
wherein the microfluidic device is capable of precise sampling.

22. The device of claim 21, further comprising one or more first biogenic or immunoreactive substances arranged in said reaction chamber and one or more second biogenic or immunoreactive substances arranged in connection with said conductive surface in or defining at least part of each of said at least one detection chamber.

23. A rapid assay kit, comprising:
a housing defining a sample well;
the device of claim 1, said inlet chamber aligning with said sample well; and
a filter arranged between said sample well and said inlet chamber.

24. The kit of claim 23, wherein said housing further comprises a first window aligning with said reaction chamber to enable determination of the presence of sample fluid in said reaction chamber.

25. The kit of claim 23, wherein said housing further comprises at least one window, each in alignment with a respective one of said at least one detection chamber.

26. A rapid assay kit, comprising:
a housing defining a sample well and including apertures; and
the device of claim 17, said inlet chamber aligning with said sample well, said electrical interconnection unit extending through said apertures to enable the rapid assay kit to be connected to a reading unit.

27. A method for testing a sample fluid for the presence of one or more specific materials, comprising:
arranging the device of claim 17 in a housing defining a sample well and including apertures such that said inlet chamber aligns with said sample well and said electrical interconnection unit extends through said apertures;
placing an amount of sample fluid in said sample well, the sample fluid flowing through said photoresist layer;
inserting said housing into a reading unit until contact in the reading unit with said electrical interconnection unit;
activating a microcontroller in said reading unit to complete an electrical circuit with said electrical interconnection unit and determine a capacitance or voltage change through said electrical interconnection unit; and
correlating the determined capacitance or voltage change to the presence or absence of the materials.

28. A method for testing a sample fluid for the presence of one or more specific materials, comprising:
arranging the device of claim 1 in a housing defining a sample well and at least one window such that said inlet chamber aligns with said sample well, each of said at least one window aligning with a respective one of said at least one detection chamber;
placing an amount of sample fluid in said sample well, the sample fluid flowing through said photoresist layer;
monitoring a last one of said at least one window to ascertain when the sample fluid has reached the last one of said at least one detection chamber;
measuring fluorescence or optical intensity of said at least one detection chamber; and
correlating the determined fluorescent or optical intensity change to the presence or absence of the materials.

29. A one-step electrochemical sensor device, comprising:
a photoresist layer defining an inlet chamber adapted to receive a sample fluid to be tested, a reaction chamber in fluid communication with said inlet chamber, at least one detection chamber in fluid communication with said inlet chamber, and an absorbent chamber downstream of said at least one detection chamber in the direction of flow of the sample fluid;
a support structure arranged under said photoresist layer for providing rigid support for said photoresist layer;
a cover arranged above said photoresist layer for covering said reaction chamber, said at least one detection chamber and said absorbent chamber; and
a conductive surface in or defining at least part of said at least one detection chamber,
wherein said absorbent chamber comprises at least one absorbent channel and said absorbent channel includes an open end; and
wherein the microfluidic device is capable of precise sampling.

30. The electrochemical sensor device of claim 29, further comprising an electrical interconnection unit having said conductive surface in or defining at least part of said at least one detection chamber and connector pins on opposite sides of said conductive surface, whereby particles in the sample fluid react with said conductive surface and cause a variation in current through said conductive surface which is detectable by forming a circuit with said connector pins.

31. The rapid assay kit of claim 26, further comprising a filter arranged between said sample well and said inlet chamber.

32. The microfluidic device of claim 1, wherein the surface of the photoresist layer is hydrophilic.

33. A one-step microfluidic device, comprising:
a photoresist layer defining an inlet chamber adapted to receive a sample fluid to be tested, a reaction chamber in fluid communication with said inlet chamber, at least one detection chamber in fluid communication with said reaction chamber, and a set of absorbent channels downstream of said at least one detection chamber in the direction of flow of the sample fluid;
a support structure arranged under said photoresist layer for providing rigid support for said photoresist layer; and
a cover arranged above said photoresist layer for covering said reaction chamber, said at least one detection chamber and said set of absorbent channels,
wherein one or more first biogenic or immunoreactive substances are arranged in said reaction chamber and one or more second biogenic or immunoreactive substances are arranged in each of said at least one detection chamber;
wherein said set of absorbent channels defines a plurality of parallel channels communicating at an inlet end with a last one of said at least one detection chamber;
wherein said absorbent channels include open ends; and
wherein the microfluidic device is capable of precise sampling.

34. The microfluidic device of claim 33, wherein the surface of the photoresist layer is hydrophilic.

35. (canceled)

36. The microfluidic device of claim 33, wherein said one or more first biogenic or immunoreactive substances arranged in said reaction chamber include fluorescence labels or electrochemical labels.
